(19) United States
(12) Patent Application Publication
(10) Pub. No.: US 2008/0242369 A1
(43) Pub. Date: Oct. 2, 2008

(54) PORTABLE ELECTRONIC APPARATUS

(75) Inventors: Satoshi Kazuta, Tokyo (JP); Yuichi Inoue, Tokyo (JP); Hitoshi Suzuki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/840,319

(22) Filed: Aug. 17, 2007

(30) Foreign Application Priority Data
Mar. 28, 2007 (JP) 2007-085168

(51) Int. Cl. H04M 1/00; H02J 7/00

(52) U.S. Cl. 455/573; 320/134

(57) ABSTRACT

When a host PC acts as a host and communicates with a portable electronic apparatus, the portable electronic apparatus can release connection between the portable electronic apparatus and the host PC in no response to the host PC and in accordance with an amount of remaining power of a rechargeable battery. Also, the release of the connection between the portable electronic apparatus and the host PC results in that it is possible to avoid an access error for an HDD due to a shortage in the amount of remaining power of the rechargeable battery, and thus it is possible to prevent media data from being damaged due to the shortage in the amount of remaining power of the rechargeable battery.

The present application is based on Japanese patent application No. 2007-085168, the entire contents of which are incorporated herein by reference.

### BACKGROUND

1. Field

One embodiment of the invention relates to a portable electronic apparatus.

2. Description of the Related Art

A portable electronic apparatus which, when an amount of power consumption differs depending on update contents of a software in updating the software operating on the portable electronic apparatus, determines whether or not a software updating work should be performed in accordance with the amount of power consumption and a remaining power of a battery of the portable electronic apparatus is known as conventional one. This portable electronic apparatus, for example, is described in the Japanese Patent Kokai No. 2005-182265.

This portable electronic apparatus includes a power source-inputting portion for selecting a power supply source from a battery built therein and an external power source, thereby changing one of them over to the other, a card slot portion into which an external memory card for storing therein a program for updating software is detachably inserted, and a control portion for controlling the power source-inputting portion and the card slot portion. When the power source-inputting portion selects the battery as the power supply source, the control portion detects an amount of remaining power of the battery through the power-inputting portion, and calculates an amount of power consumption required for the work for updating the software by referring to the program stored in the external memory card detachably inserted into the card slot portion. Thus, only when the amount of remaining power of the battery is more than the amount of power consumption required for execution of the program, the control portion authorizes the execution of the software updating work.

When the amount of remaining power of the battery is less than the amount of power consumption required for the software updating work, the portable electronic apparatus rejects the execution of the software updating work. Therefore, it is possible to prevent a failure in the software updating work due to an electric power shortage, and thus it is possible to prevent the data from being damaged due to the failure in the software updating work. In addition, unlike the case where the operation of the portable electronic apparatus is judged in accordance with a predetermined threshold set for the amount of remaining power of the battery, even when the amount of remaining power of the battery is less, the software updating work can be performed within a limit of the amount of remaining power of the battery as long as the software updating work requires the less amount of power consumption.

However, according to the conventional portable electronic apparatus, when the program for updating is stored in the memory card inserted into the card slot of the portable electronic apparatus, that is, when the program for updating is contained inside the portable electronic apparatus, the execution of the program can be controlled in accordance with the amount of remaining power of the battery. However, for example, in the case where an external apparatus performs an operation as a host for a communication when the portable electronic apparatus communicates with the external apparatus, that is, in the case where no program is contained inside the portable electronic apparatus, there is encountered a problem that the performance of the communication cannot be controlled in accordance with to the amount of remaining power of the battery by utilizing the same method as that of the above case because the portable electronic apparatus itself has no authority for the execution of the program.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing a portable electronic apparatus according to a first embodiment of the invention, and a host PC connected to the portable electronic apparatus of the first embodiment;

FIG. 2 is an exemplary block diagram showing a configuration of the portable electronic apparatus according to the first embodiment of the invention;

FIG. 3 is an exemplary block diagram showing a configuration of the host PC connected to the portable electronic apparatus according to the first embodiment of the invention;

FIG. 4 is an exemplary flow chart showing an operation of the portable electronic apparatus according to the first embodiment of the invention;

FIG. 5 is an exemplary flow chart showing an operation of a portable electronic apparatus according to a second embodiment of the invention, and an operation of a host PC connected to the portable electronic apparatus of the second embodiment; and

FIG. 6 is an exemplary flow chart showing an operation of a portable electronic apparatus according to a third embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a portable electronic apparatus, including: a communication portion connected to an outside for transmitting/receiving data to/from the outside, and receiving an electric power supplied from the outside; a storage portion for storing therein the data received from the outside; a rechargeable battery adapted to be charged with electricity through the communication portion; and a control portion for detecting an amount of remaining power of the rechargeable battery during performance of transmission/reception of the data through the communication portion, and releasing connection between the communication portion and the outside in accordance with the amount of remaining power of the rechargeable battery.

According to the one embodiment of the invention constituted as described above, when communicating with the outside acting as a host, the portable electronic apparatus can release the connection between the communication portion and the outside in accordance with the amount of remaining power of the rechargeable battery. In addition, the release of the connection between the communication portion and the outside results in that it is possible to avoid an access error for the storage portion due to a shortage of the amount of remaining power of the rechargeable battery, and thus it is possible to prevent the data stored in the storage portion from being damaged due to the access error for the storage portion.

In addition, according to a further embodiment of the invention, there is provided a portable electronic apparatus, including: a communication portion connected to an outside for transmitting/receiving data to/from the outside, and receiving an electric power supplied from the outside; a storage portion for storing therein the data received from the outside; a rechargeable battery adapted to be charged with electricity through the communication portion; and a control portion for detecting an amount of remaining power of the rechargeable battery during performance of transmission/reception of the data to/from the outside through the communication portion, and transmitting a request signal to temporarily stop a communication between the communication portion and the outside in accordance with the amount of remaining power of the rechargeable battery.

According to the further embodiment of the invention constituted as described above, the portable electronic apparatus transmits the request signal to the outside, which results in that the state of the communication between the communication portion and the outside can be controlled in accordance with the state of the rechargeable battery without releasing the connection between the communication portion and the outside.

Also, according to a still further embodiment of the invention, there is provided a portable electronic apparatus, including: a communication portion connected to an outside for transmitting/receiving data to/from the outside, and receiving an electric power supplied from the outside; a storage portion for storing therein the data received from the outside; a rechargeable battery adapted to be charged with electricity through the communication portion; and a control portion for detecting an amount of remaining power of the rechargeable battery, and determining whether or not connection between the communication portion and the outside should be started in accordance with the amount of remaining power of the rechargeable battery.

According to the still further embodiment of the invention constituted as described above, the portable electronic apparatus determines whether the connection between the communication portion and the outside should be authorized or inhibited in accordance with the amount of remaining power of the rechargeable battery before the communication portion is connected to the outside. Therefore, even when the outside acts as a host for the communication, the portable electronic apparatus can control its connection with the outside.

According to the embodiments of the invention, the portable electronic apparatus can safely communicate with the external apparatus in accordance with the amount of remaining power of the rechargeable battery.

Preferred embodiments of the invention will be described in detail hereinafter with reference to the accompanying drawings.

### First Embodiment

### (Constitution)

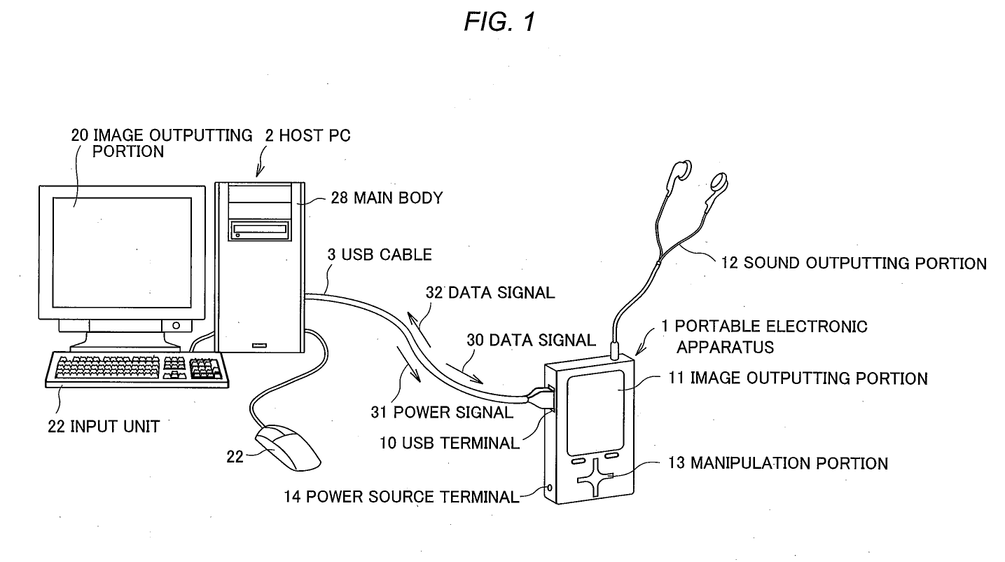

FIG. 1 is a schematic view showing a portable electronic apparatus according to a first embodiment of the invention, and a host PC connected to the portable electronic apparatus of the first embodiment.

The portable electronic apparatus 1 and the host personal computer (PC) 2 as an external apparatus are connected to each other through a universal serial bus (USB) cable 3. The host PC 2 transmits a data signal 30 and a power signal 31 to the portable electronic apparatus 1, while the portable electronic apparatus 1 transmits a data signal 32 to the host PC 2. Note that, the connection stated herein means a state in which not only opposite terminals of the USB cable 3 are plugged into USB terminals 10 and 23 of the portable electronic apparatus 1 and the host PC 2, respectively, but also the portable electronic apparatus 1 and the host PC 2 recognize the mutual connection.

The portable electronic apparatus 1 includes the USB terminal 10 into which one terminal of the USB cable 3 is plugged, an image outputting portion 11 for displaying thereon an image of characters, figures or the like, a sound outputting portion 12 as an external sound-outputting portion such as a speaker, a headphone or an earphone for outputting therethrough a sound, a manipulation portion 13 having a plurality of manipulation switches, and a power source terminal 14 to which an external power source such as an A.C. adopter is connected, and thus to which a power can be supplied from the outside.

The host PC 2 includes an image outputting portion 20 for displaying thereon an image of characters, figures or the like, an input unit 22 including an input device having a mouse, a keyboard, and the like, and a main body 28 having electronic units such as a hard disc drive (HDD) and a CPU. Also, the other terminal of the USB cable 3 is connected to the USB terminal 23 (not shown in FIG. 1) provided in a back face of the main body 28.

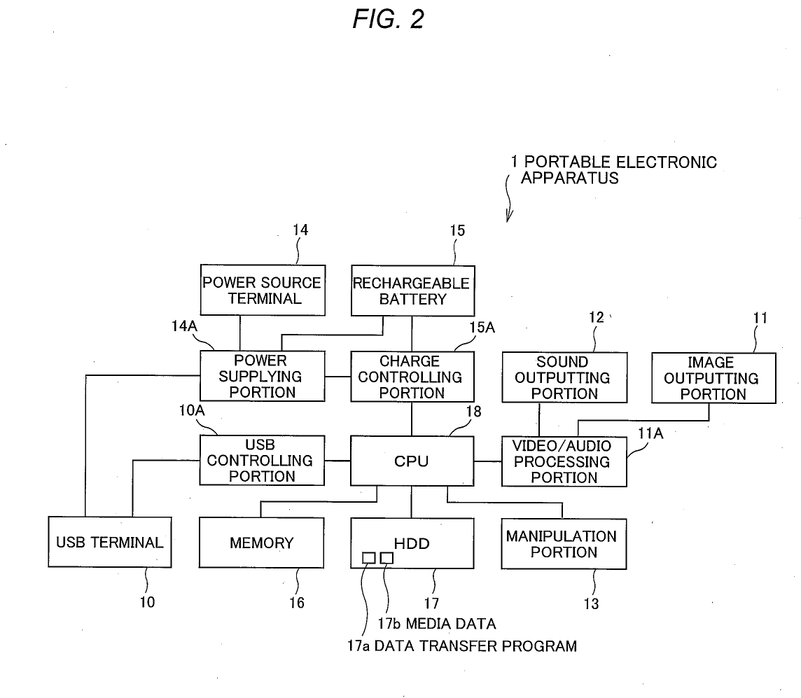

FIG. 2 is a block diagram showing a configuration of the portable electronic apparatus according to the first embodiment of the invention.

The portable electronic apparatus 1 includes the USB terminal 10 into which one terminal of the USB cable 3 is plugged, and through which the portable electronic apparatus 1 transmits/receives the data to/from the host PC 2, and receives the power supplied thereto from the host PC 2, the image outputting portion 11 for displaying thereon an image of characters, figures and the like, the sound outputting portion 12 for outputting a sound to the outside acting as the external sound-outputting portion such as a speaker, a headphone or an earphone, the manipulation portion 13 having a plurality of switches, the power source terminal 14 to which the external power source such as an A.C. adapter is connected, and thus through which the portable electronic apparatus 1 receives the power supplied from the outside, a rechargeable battery 15 which can be charged with electricity by receiving the power supplied from the host PC 2 or the outside through the USB terminal 10 or the power source terminal 14, respectively, a memory 16 for temporarily storing therein data received from the host PC 2, and an HDD 17 which can receive the data temporarily stored in the memory 16, thereby storing therein the data thus received.

In addition, the portable electronic apparatus 1 includes a USB controlling portion 10A connected to the USB terminal 10 for controlling transmission/reception of the data to/from the host PC 2, a video/audio processing portion 11A for outputting a video signal and an audio signal to the image outputting portion 11 and the sound outputting portion 12, respectively, a power supplying portion 14A for receiving a power supplied from the host PC 2 or the outside through the USB terminal 10 or the power source terminal 14, respectively, and supplying the power thus received to each of the portions except for the USB terminal 10 and the power source terminal 14, and corresponding portions (not shown) of the portable electronic apparatus 1, a charge controlling portion ISA for receiving the power supplied from the power supplying portion 14A, thereby charging the rechargeable battery 15 with electricity, and monitoring an amount of remaining power of the rechargeable battery 15, and a CPU 18 for controlling the portions except for the USB terminal 10 and the power source terminal 14, and the corresponding portions (not shown) of the portable electronic apparatus 1.

The HDD 17 stores therein a data transfer program 17a which is executed on the CPU 18 in order that the portable electronic apparatus 1 may transmit/receive the data to/from the host PC 2 through the USB cable 3 and the USB terminal 10, and in accordance with which the portable electronic apparatus 1 communicates with the host PC 2, and media data 17b as transfer data which the portable electronic apparatus 1 receives from the host PC 2. Note that, the communication stated herein means a state in which, after the portable electronic apparatus 1 and the host PC 2 are connected to each other, the portable electronic apparatus 1 and the host PC 2 can transmit data to each other, and the portable electronic apparatus 1 and the host PC 2 can transmit a calling or a response to the calling to each other.

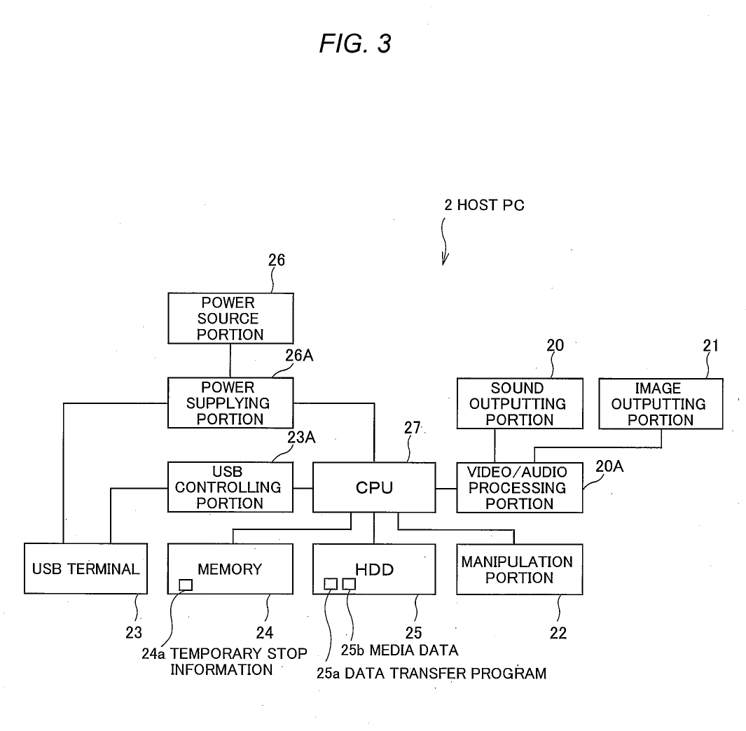

FIG. 3 is a block diagram showing a configuration of the host PC adapted to be connected to the portable electronic apparatus according to the first embodiment of the invention.

The host PC 2 includes the image outputting portion 20 for displaying thereon an image of characters, figures or the like, a sound outputting portion 21 for outputting a sound to the outside as an external sound-outputting portion such as a speaker or an earphone, the input unit 22 including an input device such as a mouse or a keyboard, a USB terminal 23 into which the other terminal of the USB cable 3 is plugged in order that the host PC 2 may transmit/receive data to/from the portable electronic apparatus 1, and through which the power is supplied to the portable electronic apparatus 1, a memory 24 for temporarily storing therein data when the data is intended to be outputted to the portable electronic apparatus 1, an HDD 25 which can store therein data, and a power source portion 26 for receiving a power supplied thereto from the outside.

In addition, the host PC 2 includes a video/audio processing portion 20A for outputting a video signal and an audio signal to the image outputting portion 20 and the sound outputting portion 21, respectively, a USB controlling portion 23A connected to the USB terminal 23 for controlling transmission/reception of data to/from the portable electronic apparatus 1, a power supplying portion 26A for supplying a power to each of the portions except for the power source portion 26, and corresponding portions (not shown) of the host PC 2, and supplying the power to the portable electronic apparatus 1 through the USB terminal 23, and a CPU 27 for controlling the portions except for the power source portion 26, and the corresponding portions (not shown) of the host PC 2.

When the post PC 2 temporarily stops the transmission of the data during the transmission of the data, the memory 24 stores therein temporary stop information 24a as a resume point.

The HDD 25 stores therein a data transfer program 25a which is executed on the CPU 27 in order that the host PC 2 may communicate with the portable electronic apparatus 1 through the USB terminal 23 and the USB cable 3, and in accordance with which the host PC 2 transmits/receives transfer data to/from the portable electronic apparatus 1, and media data 25b as contents data on a sound, an image, a moving image or the like which is to be transmitted to the portable electronic apparatus 1.

### (Operation)

An operation of the portable electronic apparatus according to the first embodiment of the invention will be described in detail hereinafter with reference to FIGS. 1 to 4.

When the portable electronic apparatus 1 and the host PC 2 are connected to each other through the USB cable 3, firstly, the host PC 2 acts as a host, and starts a negotiation with the portable electronic apparatus 1 in accordance with the data transfer program 25a. The portable electronic apparatus 1 responds to the negotiation with the portable electronic apparatus 1 in accordance with the data transfer program 17a stored in the HDD 17, and determines communication setting for timings of a calling and a response to the calling, a communication speed, and the like. The data signals 30 and 32 are ones which are transmitted between the portable electronic apparatus 1 and the host PC 2 during the communication between them. Also, the power signal 31 is one which is supplied in the form of an electric power from the host PC 2 to the portable electronic apparatus 1.

After completion of the negotiation with the portable electronic apparatus 1, the host PC 2 transmits the media data 25b to the portable electronic apparatus 1 through the USB terminal 23 in accordance with the data transfer program 25a by being manipulated by a user. In order to improve the communication speed during the transmission of the media data 25b, the media data 25b is transmitted in the form of transfer data to the portable electronic apparatus 1 through the CPU 27 and the USB controlling portion 23A after being temporarily preserved in the memory 24.

The media data 25b transmitted from the host PC 2 is received in the form of transfer data by the portable electronic apparatus 1 through the USB terminal 10 in accordance with the data transfer program 17a, and is stored as the media data 17b in the HDD 17. In order to improve the communication speed during the reception of the transfer data (the media data 17b), the received transfer data is written to the HDD 17 after being temporarily preserved in the memory 16.

During the communication about the transfer data, the host PC 2 supplies the power in the form of the power signal 31 to the portable electronic apparatus 1. The power supplied to the portable electronic apparatus 1 is inputted to the power supplying portion 14A, so that the power supplying portion 14A supplies the power thus inputted thereto to each of the portions except for the USB terminal 10 and the power source terminal 14, and the corresponding portions (not shown) of the portable electronic apparatus 1. The power which is more than that supplied to the portable electronic apparatus 1 through the USB cable 3 is consumed in the HDD 17 during the communication about the transfer data. Therefore, when no power is supplied to the portable electronic apparatus 1 through the power source terminal 14, the rechargeable battery 15 supplies the HDD 17 with a power for a shortage. A description of this embodiment will be continued hereinafter under the condition that no power is supplied to the portable electronic apparatus 1 through the power source terminal 14.

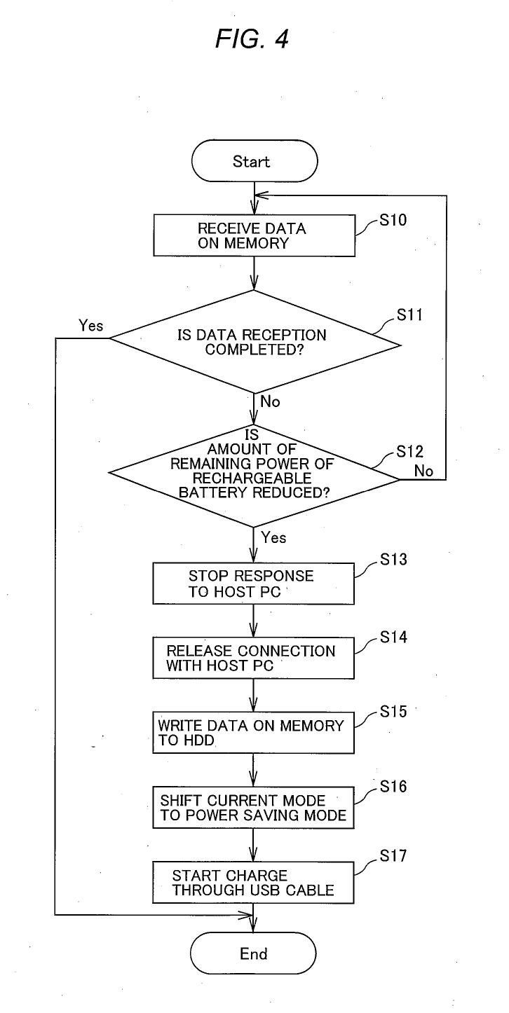

FIG. 4 is a flow chart showing the operation of the portable electronic apparatus according to the first embodiment of the invention.

Firstly, when receiving the transfer data from the host PC 2 through the USB cable 3, the portable electronic apparatus 1 transmits a reception response to the transfer data to the host PC 2, and also stores the transfer data in the memory 16 (Step S10). The CPU 18 monitors an amount of remaining power of the rechargeable battery 15 through the charge controlling portion 15A. Thus, when the CPU 18 perceives that the amount of remaining power of the rechargeable battery 15 is insufficient (Step S12: Yes) before the transfer of the transfer data is completed (Step S11: No), the USB controlling portion 15A stops the transmission of the reception response to the host PC 2 (Step S14). More specifically, the transmission of the reception response is stopped by pulling down a state of a data line formed by connecting the portable electronic apparatus 1 and the host PC 2 to each other through the USB cable 3. On the other hand, when the CPU 18 perceives that the amount of remaining power of the rechargeable battery 15 is sufficient (Step S12: No), the operation returns back to the processing in Step S10.

When the reception response is not transmitted from the portable electronic apparatus 1 to the host PC 2 for a given period of time, the host PC 2 releases the connection between the portable electronic apparatus 1 and the host PC 2 (Step S14). When the connection between the portable electronic apparatus 1 and the host PC 2 is released, the portable electronic apparatus 1 preserves the transfer data which is temporarily preserved in the memory 16 as the media data 17b in the HDD 17 (Step S15).

Next, the operation mode of the portable electronic apparatus 1 proceeds to a power saving mode in which a luminance of the image outputting portion 11 is reduced, a rotational frequency of the HDD 17 is reduced, and so forth, thereby suppressing the power consumption in each of the corresponding portions (Step S16). The charge controlling portion ISA charges the rechargeable battery 15 with the power supplied from the host PC 2 through the USB cable 3 (Step S17).

According to the above-mentioned first embodiment of the invention, when the host PC 2 acts as the host and communicates with the portable electronic apparatus 1, the portable electronic apparatus 1 can release the connection between the portable electronic apparatus 1 and the host PC 2 in no response to the host PC 2 and in accordance with the amount of remaining power of the rechargeable battery 15. In addition, the release of the connection between the portable electronic apparatus 1 and the host PC 2 results in that it is possible to avoid the access error for the HDD 17 due to the shortage in the amount of remaining power of the rechargeable battery 15, and thus it is possible to prevent the media data 17b from being damaged due to the access error for the HDD 17.

### Second Embodiment

### (Operation)

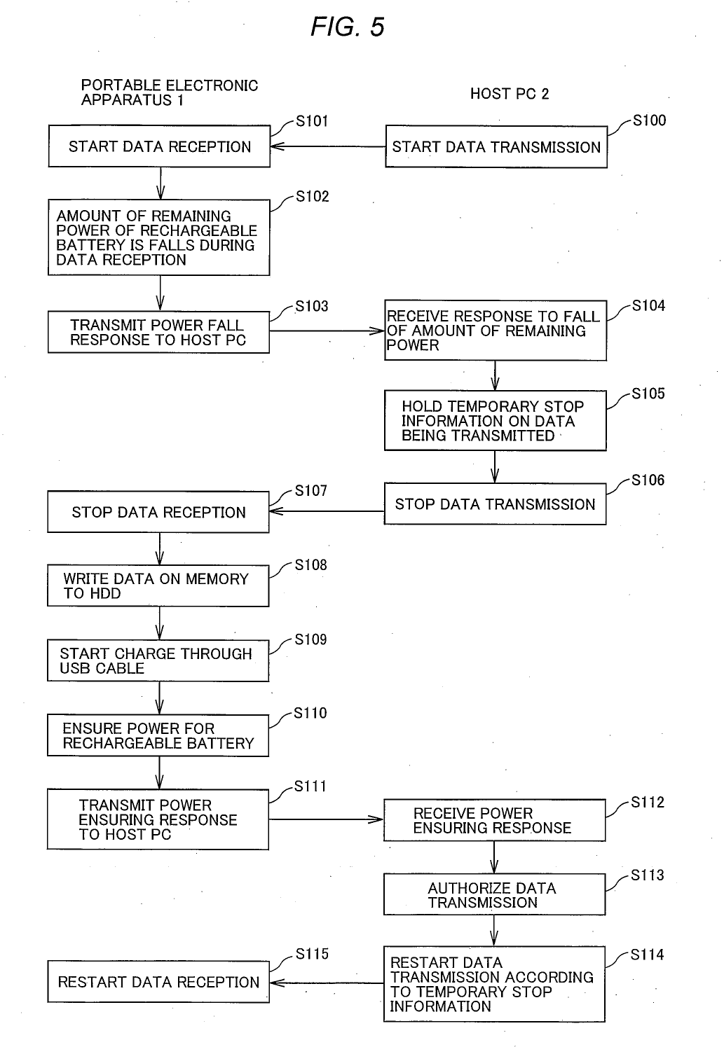

FIG. 5 is a flow chart showing an operation of a portable electronic apparatus according to a second embodiment of the invention, and an operation of the host PC connected to the portable electronic apparatus of the second embodiment. Here, in the following description, portions having the same constitutions and functions as those in the first embodiment are designated with the same reference numerals, respectively.

In this embodiment, As a negotiation, the portable electronic apparatus 1 and the host PC 2 are set such that the host PC 2 periodically calls the portable electronic apparatus 1 while it is connected to the portable electronic apparatus 1, and the portable electronic apparatus 1 responds to the case where the power of the rechargeable battery 15 falls, and the case where the power of the rechargeable battery 15 returns to the normal one, thereby informing the host PC 2 of the state of the amount of remaining power of the rechargeable battery 15. Also, it is assumed that the setting thus made is reflected in each of the data transfer program 17a and the data transfer program 25a.

Firstly, after temporarily preserving the media data 25b in the memory 24, the host PC 2 transmits the media data 25b as the transfer data to the portable electronic apparatus 1 through the CPU 27, the USB controlling portion 23A, and the USB terminal 23 (Step S100).

When receiving the transfer data from the host PC 2 through the USB cable 3, the portable electronic apparatus 1 transmits a reception response to the host PC 2, and stores the transfer data thus received in the memory 16 (Step S101). As has been described above, the CPU 18 usually monitors the amount of remaining power of the rechargeable battery 15 through the charge controlling portion 15A. Thus, when detecting that the amount of remaining power of the rechargeable battery 15 falls (Step S102), the CPU 18 transmits a response representing the fall of the amount of remaining power of the rechargeable battery 15 to the host PC 2 in response to the periodical calling made by the host PC 2 (Step S103).

When receiving the remaining power fall response (Step S104), the host PC 2 stores temporary stop information as a resume point of the transmitted transfer data in the memory 24 (Step S105), and stops the transmission of the transfer data to the portable electronic apparatus 1 (Step S106).

When the transmission of the transfer data from the host PC 2 is stopped, the portable electronic apparatus 1 stops the reception of the transfer data (Step S107), and preserves the transfer data, which is temporarily stored in the memory 16, as the media data 17b in the HDD 17 (Step S108).

Next, the charge controlling portion 15A of the portable electronic apparatus 1 starts to charge the rechargeable battery 15 with the power supplied from the host PC 2 through the USB cable 3 (Step S109).

When the charge controlling portion 15A judges that the amount of power for the rechargeable battery 15 can be ensured up to a predetermined value, for example, an amount of power enough for the portable electronic apparatus 1 to operate for five minutes in the phase of the communication about the transfer data after starting to charge the rechargeable battery 15 with the power (Step S110), the portable electronic apparatus 1 transmits a power ensuring response in response to the periodical calling from the host PC 2 to the portable electronic apparatus 1 (Step Sill).

When receiving the power ensuring response from the portable electronic apparatus 1 (Step S112), the host PC 2 authorizes a transmission of the transfer data which is temporarily stopped to be transmitted again to the portable electronic apparatus 1 (Step S113), and reads out the temporary stop information 24a stored in the memory 24, thereby restarting the transmission of the transfer data from the resume point (Step S114).

The portable electronic apparatus 1 receives the transfer data thus transmitted thereto again, and transmits a reception response to the host PC 2 (Step S115).

According to the above-mentioned second embodiment of the invention, the portable electronic apparatus 1 responds to the calling made from the host PC 2, which results in that the operation of the data transfer program 25a stored in the HDD 25 of the host PC 2 can be determined in correspondence to the state of the rechargeable battery 15 of the portable electronic apparatus 1 without releasing the connection between the portable electronic apparatus 1 and the host PC 2, and the state of the communication between the portable electronic apparatus 1 and the host PC 2 can be controlled.

In addition, the temporary stop information 24a as the history of the transmission of the transfer data is stored in the memory 24, thereby making it possible to restart the data transfer from the resume point. As a result, a period of time required for the data transfer can be suppressed to a minimum without redoing the data transfer from the start.

### Third Embodiment

### (Operation)

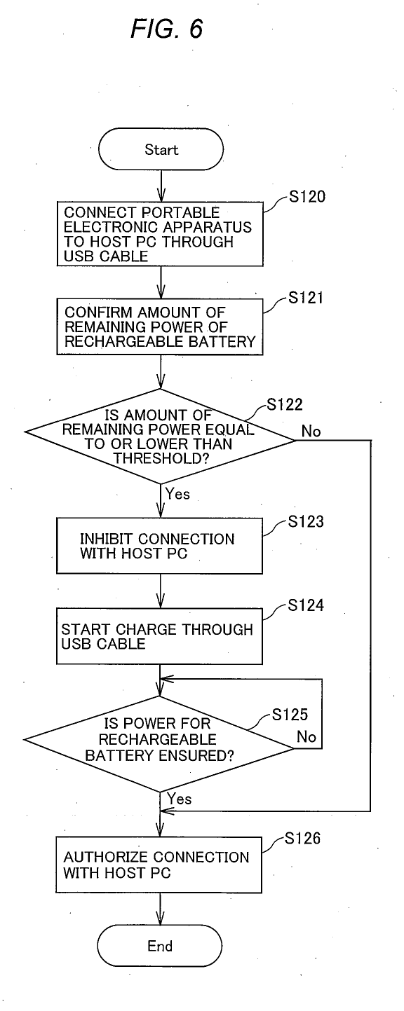

FIG. 6 is a flow chart showing an operation of a portable electronic apparatus according to a third embodiment of the invention.

Firstly, when the portable electronic apparatus 1 and the host PC 2 are connected to each other through the USB cable 3 (Step S120), the portable electronic apparatus 1 accesses the charge controlling portion 15A to confirm the amount of remaining power of the rechargeable battery 15 before the host PC 2 starts a negotiation with the portable electronic apparatus 1 (Step S121).

When the portable electronic apparatus 1 judges that the amount of remaining power of the rechargeable battery 15 is equal to or lower than a certain threshold, for example, equal to or lower than a power merely enough to allow the data transfer operation to be continuously performed for five minutes (Step S122: Yes), the CPU 18 instructs the USB controlling portion 10A to inhibit the connection with the host PC 2 through the USB cable 3 in accordance with the data transfer program 17a (Step S123).

Although the portable electronic apparatus 1 and the host PC 2 are not connected to each other for the communication, the portable electronic apparatus 1 charges the rechargeable battery 15 with the power supplied from the host PC 2 through the USB cable 3 because it is connected to the host PC 2 through the USB cable 3 (Step S124).

When the portable electronic apparatus 1 judges that the power merely enough to allow the data transfer operation to be continuously performed for five minutes is ensured from the result of monitoring the amount of remaining power of the rechargeable battery 15 by the charge controlling portion 15A (Step S125: Yes), or when that power is previously ensured in the processing in Step S112 (Step S122: No), the CPU 18 authorizes the USB controlling portion 10A to connect the portable electronic apparatus 1 to the host PC 2 through the USB cable 3 in accordance with the data transfer program 17a (Step S126). On the other hand, when the portable electronic apparatus 1 judges that the power merely enough to allow the data transfer operation to be continuously performed for five minutes is not ensured from that result (Step S125: No), the processing in Step S125 is repeatedly executed until the predetermined power for the rechargeable battery 15 is ensured.

According to the above-mentioned third embodiment of the invention, the portable electronic apparatus 1 determines whether the connection between the portable electronic apparatus 1 and the host PC 2 should be authorized or inhibited before the host PC 2 starts a negotiation with the portable electronic apparatus 1 in accordance with the amount of remaining power of the rechargeable battery 15. Therefore, even when the host PC 2 acts as the host for the communication, the portable electronic apparatus 1 can control its connection with the host PC 2.

In addition, when the portable electronic apparatus 1 judges that the predetermined power of the rechargeable battery 15 is ensured, the CPU 18 authorizes the USB controlling portion 10A to connect the portable electronic apparatus 1 to the host PC 2. Therefore, the data transfer can be safely performed without damaging any of the data preserved in the HDD 17.

What is claimed is:

1. A portable electronic apparatus, comprising:
a communication portion connected to an outside for transmitting/receiving data to/from the outside, and receiving an electric power supplied from the outside;
a storage portion for storing therein the data received from the outside;
a rechargeable battery adapted to be charged with electricity through the communication portion; and
a control portion for detecting an amount of remaining power of the rechargeable battery during performance of transmission/reception of the data through the communication portion, and releasing connection between the communication portion and the outside in accordance with the amount of remaining power of the rechargeable battery.

2. A portable electronic apparatus according to claim 1, wherein after releasing the connection between the communication portion and the outside, the control portion charges the rechargeable battery with electricity through the communication portion.

3. A portable electronic apparatus according to claim 1, wherein after releasing the connection between the communication portion and the outside, the control portion performs setting for the corresponding portions so that power consumption is suppressed in each of the corresponding portions.

4. A portable electronic apparatus according to claim 2, wherein while charging the rechargeable battery with electricity through the communication portion, the control portion performs setting for the corresponding portions so that power consumption is suppressed in each of the corresponding portions.

5. A portable electronic apparatus according to claim 1, wherein the control portion instructs the communication portion to operate so as to be disconnected from the outside in no response to the outside.

6. A portable electronic apparatus according to claim 1, wherein the storage portion includes a memory and a hard disc drive (HDD), and after releasing the connection between the communication portion and the outside, the control portion preserves the data which is received from the communication portion and is temporarily preserved in the memory before the release of the connection between the communication portion and the outside in the HDD of the storage portion.

7. A portable electronic apparatus, comprising:
a communication portion connected to an outside for transmitting/receiving data to/from the outside, and receiving an electric power supplied from the outside;
a storage portion for storing therein the data received from the outside;
a rechargeable battery adapted to be charged with electricity through the communication portion; and
a control portion for detecting an amount of remaining power of the rechargeable battery during performance of transmission/reception of the data to/from the outside through the communication portion, and transmitting a request signal to temporarily stop a communication between the communication portion and the outside in accordance with the amount of remaining power of the rechargeable battery.

8. A portable electronic apparatus according to claim 7, wherein after temporarily stopping the communication between the communication portion and the outside, the control portion charges the rechargeable battery with electricity through the communication portion.

9. A portable electronic apparatus according to claim 7, wherein after temporarily stopping the communication between the communication portion and the outside, the control portion performs setting for the corresponding portions so that power consumption is suppressed in each of the corresponding portions.

10. A portable electronic apparatus according to claim 8, wherein while charging the rechargeable battery with electricity through the communication portion, the control portion performs setting for the corresponding portions so that power consumption is suppressed in each of the corresponding portions.

11. A portable electronic apparatus according to claim 8, wherein when a predetermined amount of power is ensured for the rechargeable battery, the control portion transmits a request signal to restart the communication between the communication portion and the outside to the outside.

12. A portable electronic apparatus according to claim 10, wherein when a predetermined amount of power is ensured for the rechargeable battery, the control portion transmits a request signal to restart the communication between the communication portion and the outside to the outside.

13. A portable electronic apparatus according to claim 11, wherein when restarting the communication between the communication portion and the outside, the control portion transmits a request signal to restart the data transmission in accordance with temporary stop information stored in the outside to the outside.

14. A portable electronic apparatus according to claim 12, wherein when restarting the communication between the communication portion and the outside, the control portion transmits a request signal to restart the data transmission in accordance with temporary stop information stored in the outside to the outside.

15. A portable electronic apparatus according to claim 7, wherein the storage portion includes a memory and an HDD, and after temporarily stopping the communication between the communication portion and the outside, the control portion preserves the data which is received from the communication portion and is temporarily preserved in the memory before the temporary stop of the communication. between the communication portion and the outside in the HDD of the storage portion.

16. A portable electronic apparatus, comprising:
a communication portion connected to an outside for transmitting/receiving data to/from the outside, and receiving an electric power supplied from the outside;
a storage portion for storing therein the data received from the outside;
a rechargeable battery adapted to be charged with electricity through the communication portion; and
a control portion for detecting an amount of remaining power of the rechargeable battery, and determining whether or not connection between the communication portion and the outside should be started in accordance with the amount of remaining power of the rechargeable battery.

17. A portable electronic apparatus according to claim 16, wherein when not authorizing the communication portion to be connected to the outside, the control portion charges the rechargeable battery with electricity through the communication portion.

18. A portable electronic apparatus according to claim 16, wherein when not authorizing the communication portion to be connected to the outside, the control portion performs setting for the corresponding portions so that power consumption is suppressed in each of the corresponding portions.

19. A portable electronic apparatus according to claim 17, wherein while charging the rechargeable battery with electricity through the communication portion, the control portion performs setting for the corresponding portions so that power consumption is suppressed in each of the corresponding portions.

20. A portable electronic apparatus according to claim 17, wherein when a predetermined amount of power is ensured for the rechargeable battery, the control portion authorizes the communication portion to be connected to the outside.
